(19) United States
(12) Patent Application Publication
(10) Pub. No.: US 2007/0175522 A1
(43) Pub. Date: Aug. 2, 2007

(54) Check valves of multiple-layer films

(76) Inventors: Cheng-Yung Chen, Taipei (TW); Hung-Pin Lai, Taipei (TW)

Correspondence Address: Cheng-Yung Chen, P.O. BOX 29-313, Taipei, 11699, TW

(21) Appl. No.: 11/341,928

(22) Filed: Jan. 30, 2006

(51) Int. Cl. F16K 15/14

(52) U.S. Cl. 137/512.1

(57) ABSTRACT

The check valves of multiple-layer films are applicable in an inflatable gas bag, said inflatable gas bag comprises a upper film, a lower film, and check valves of multiple-layer films having a plurality of check valves being enclosed between upper film and lower film. The check valves of multiple-layer films are made by binding a first valve film, a second valve film and a third valve film using hot press. And multiple anti-welding masks are printed between first valve film and second valve film, also between second valve film and third valve film. There are two sets of passages, one between first valve film and second valve film, and another between second valve film and third valve film. The multiple sets of gas passages speed up the inflation process of the inflatable gas bag. Further, thinner valve film is used to enhance the airtight effect and to reduce the problem of gas leakage after inflation.

### BACKGROUND OF THE INVENTION

1. Field of the Invention

The present invention relates to check valves of multiple-layer films and particularly to the check valves that are involving three or more valve films to form two or more gas passages at the entrance of each gas pocket to speed up inflation process of an inflatable gas bag. The check valves of the present invention enhance the efficiency of inflation operation.

2. Brief Description of Related Art

Traditional device for protecting articles packaged therein is bubble wrap. It is able to absorb exterior impact by a plurality of uniform air pockets. The ability of absorbing impact is limited because the air pockets are too small.

U.S. Pat. No. 6,629,777 disclose a buffer packing bag comprises an air-supplying passage, an air-inflatable section, and check valves. Each of the check valves consists of two films and divided into two heat-bonded area on both length sides. A check valve body has an air-flowing passage inside the body, and an inverted V-shaped bonded area is formed with the top of the area directing to the opening in the check valve body. Because the check valve is placed at the entrance of each individual air-inflatable part, thereby the manufacturing proceeding of a buffer packing bag will be more complicated. Further, since the check valve has only one air passage, the individual air-inflatable part will not be inflated if the passage is blocked.

### SUMMARY OF THE INVENTION

An object of the present invention is to provide check valves of multiple-layer films consisting of two or more gas passages placing at the entrance of each gas pocket to speed up inflation process of an inflatable gas bag.

Another object of the present invention is to provide the check valves of multiple-layer films applying thinner valve film to enhance the airtight effect and to reduce the problem of gas leakage after inflation.

In order to achieve the preceding objects, one embodiment of the check valves of multiple-layer films consists of three layers of thin valve films hot-pressed into one piece. Hot pressing are applied in such way that multiple check valve units are formed in parallel and are evenly spaced on one piece. Before hot pressing, anti-welding masks are printed between each pair of neighboring layer of films and on each check valve location. This will allow air passages to form in each check valve unit during hot pressing. For the said embodiment, two passages are formed in each check valve unit of three valve films structure. For embodiment of check valves of n-layer films, there would be n-1 air passages formed. Multiple air passages function in parallel and therefore increase inflation speed and reliability.

An embodiment of application of present invention is placing check valves of multiple-layer films between upper film and lowing film to make an inflatable gas bag by hot pressing. Special arrangement of welding spots in hot pressing constrain valve films to upper film and accomplish air tightness after inflation of gas bag.

### BRIEF DESCRIPTION OF THE DRAWINGS

The detail structure, the applied principle, the function and the effectiveness of the present invention can be fully understood with reference to the following description and accompanying drawings, in which:

FIG. 1 is a fragmentary plan view of check valves of multiple-layer films of the present invention;

FIG. 2 is a fragmentary sectional view along line 2-2 shown in FIG. 1;

FIG. 3 is a plan view illustrating the manufacturing process of check valves films being sandwiched between upper and lower films.

FIG. 4 is a plan view of an inflatable gas bag applying check valves of the present invention before inflation;

FIG. 5 is a sectional view of an inflatable gas bag along line 5-5 shown in FIG. 4;

FIG. 6 is a plan view of an inflatable gas bag applying check valves of the present invention during inflation;

FIG. 7 is a fragmentary sectional view along line 7-7 shown in FIG. 5 during inflation;

FIG. 8 is a fragmentary sectional view along line 7-7 shown in FIG. 5 after inflation; and

FIG. 9 is a perspective view of a fully inflated gas bag applying check valves of the present invention.

### DETAILED DESCRIPTION OF THE PRESENT INVENTION

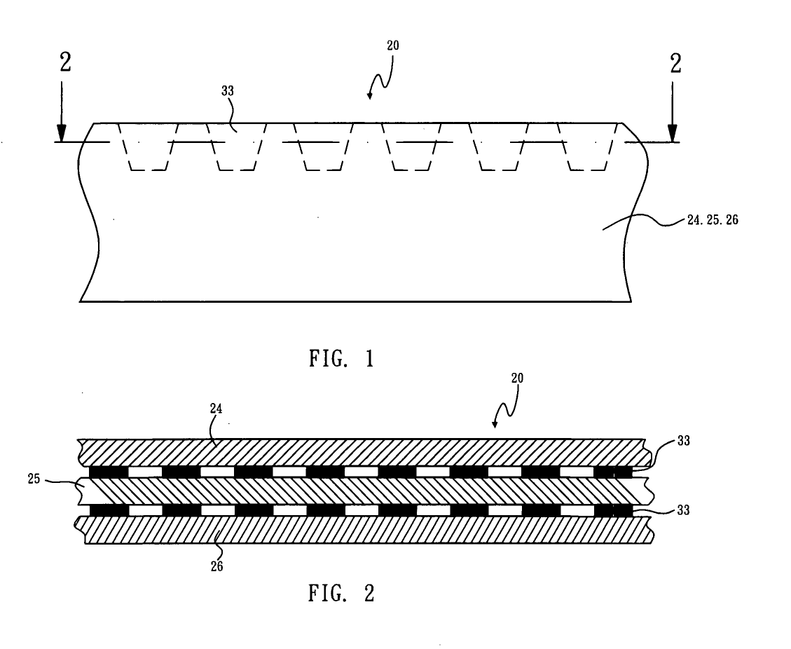

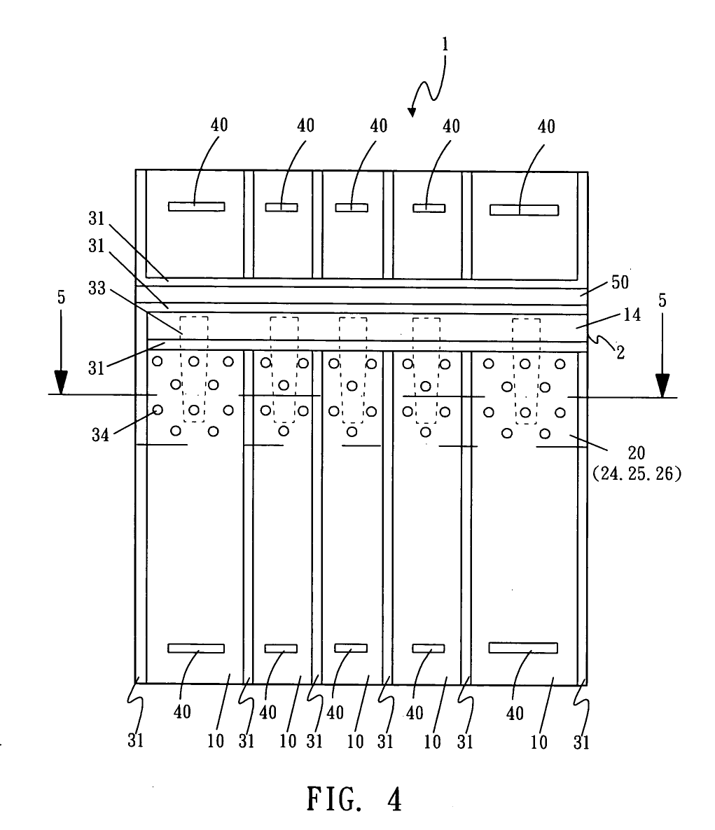

FIG. 1 shows the plan view of the check valves of multiple-layer films 20. The structure of check valves of multiple-layer films 20 is illustrated by FIG. 2, which is a fragmentary sectional view along line 2-2 shown in FIG. 1. The check valves 20 are made by binding a first valve film 24, a second valve film 25 and a third valve film 26 using hot press. Multiple anti-welding masks 33 are printed between first valve film 24 and second valve film 25, also between second valve film 25 and third valve film 26. The length and spacing of multiple anti-welding masks 33 are determined according to the multiple gas pockets 10 in the inflatable gas bag applying check valve shown in FIG. 4. The main function of anti-welding masks 33 is to prevent binding between valve films 24, 25, 26 at certain area during hot press. These unbounded areas form passages for gas during inflation, allowing gas flow from one edge of check valve (the gas channel 14 shown in FIG. 4) to another (the gas pocket 10 shown in FIG. 4). There are two sets of passages, one between first valve film 24 and second valve film 25, and another between second valve film 25 and third valve film 26. Multiple sets of gas passages speed up the inflation process of the inflatable gas bag. Thickness of an single valve film is about 20˜25 μm. The resulting thickness of check valves of multiple-layer films is about 60˜75 μm.

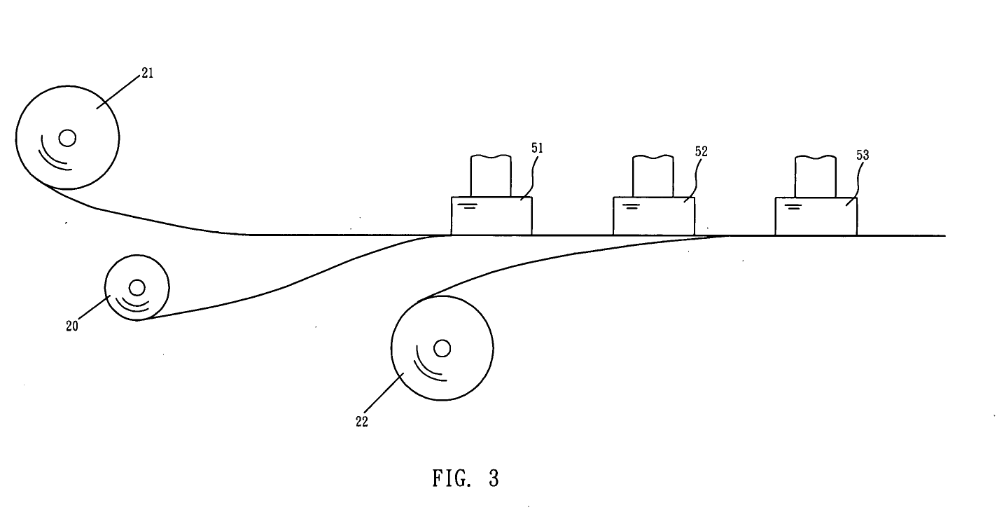

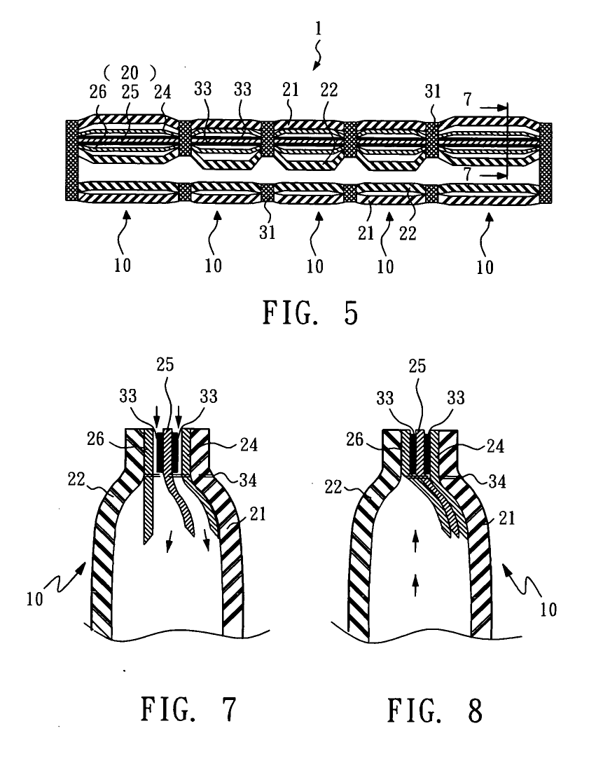

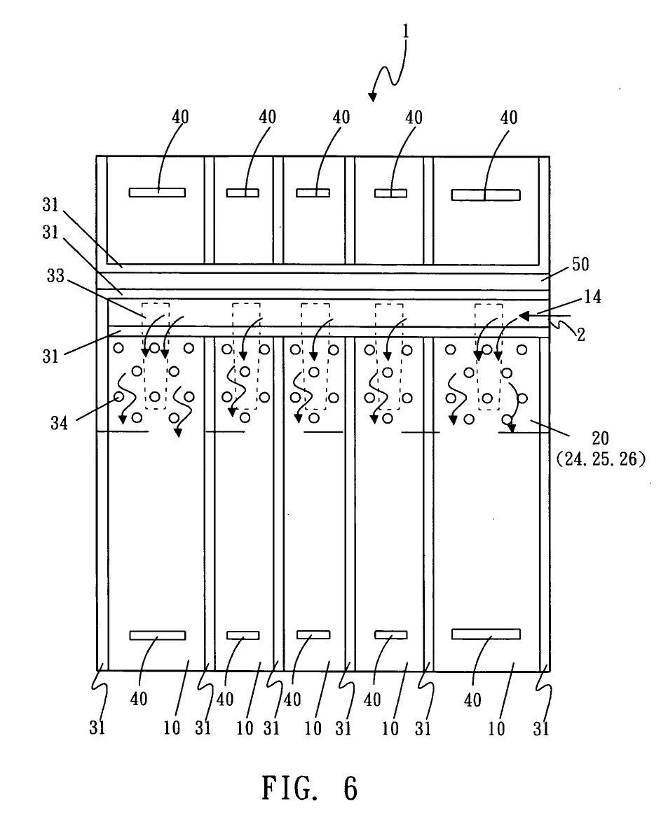

An embodiment of application of present invention is an inflatable gas bag 1 shown in FIG. 4. Manufacturing of the inflatable gas bag is illustrated in FIG. 3. A roll of check valves of multiple-layer films 20 and a roll of upper film 21 are hot pressed and bound using first mold 51. It is then further hot pressed and bound using second mold 52, which forms welding spots 34 between valve films 24, 25, 26 and upper film 21. The third mold 53 is then used to hot press and bind the previous assembly with lower film 22. The assembly is then going through the rest of process like printing, cooling, forming, folding and cutting not shown in figures. The final product is an inflatable gas bag 1 shown in FIG. 4. Noted that gas bag in FIG. 4 has been folded both on top and bottom edge to the rear side. The structure relationship of check valves of multiple-layer 20 and the inflatable gas bag 1 is shown in FIG. 5 illustrating the section view along line 5-5 in FIG. 4. The upper and lower side in FIG. 5 represents the front and rear side in FIG. 4 respectively. From these figures, it is clear that check valves 20 are enclosed between upper film 21 and lower film 22. Multiple gas pockets 10 are defined by welding lines 31 formed during hot pressing. The spacing of welding lines 31 may not be the same, allowing gas pockets 10 of various sizes on a same bag. A gas inlet 2 is arranged on one side of the inflatable gas bag. A gas channel 14 is set between gas inlet 2 and a plurality of gas pockets 10. During inflation as shown in FIG. 6, gas flows from gas inlet 2, through gas channel 14, and into each gas pocket 10. Check valve of multiple-layer films 20 is located at the entrance of gas pockets 10. The welding spots 34 on valve films 24, 25, 26 and upper film 21 constrain the valve films in such way that gas could only flow into instead of out of gas pocket 10. This check valve action is illustrated in FIGS. 7 and 8, which are fragmentary sectional views along line 7-7 shown in FIG. 5. During inflation as shown in FIG. 7, gas could pass through the gap between valve films 24 and 25, and gap between valve film 25 and 26 due to the anti-welding mask 33 which preventing binding of valve films at these masked locations. Three valve films form two gas passages, allowing larger gas flow during inflation and improving efficiency of inflation operation. After inflation as shown in FIG. 8, pressurized gas in gas pocket 10 is pressing valve films 24, 25 and 26 on to the upper film 21 and therefore making gas pocket 10 airtight. Reason for this action is that valve films 24, 25 and 26 are hot pressed and bound onto the upper film 21 through welding spots 34. They are constrained and therefore inclined to upper film 21 and away from lower film 22 after inflation. Valve films 24, 25, 26 and upper film 21 are made from thin PE film of 20˜25 μm in thickness. This makes the valve films seamlessly pressed, and therefore airtight, under pressurized gas in gas pocket 10. This greatly improves the gas leakage problem among known inflatable gas bag technology.

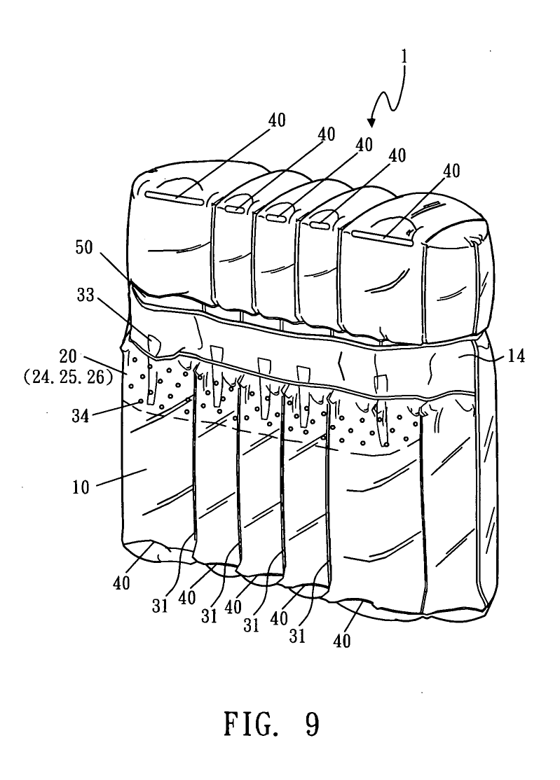

As shown in FIG. 9, an inflated gas bag is folded along folding line 40 arranged on the inflated gas pockets 10. Articles to be protected from impact and vibration during transportation could be placed in the space surrounded by the inflated gas bag. The gas channel 14 is flat because no gas is contained in it. The articles to be protected could be put in through opening 50. The flat gas channel could then be used as a cover for the opening 50.

In the previous embodiment, three valve films to form two gas passages are explained as an example. Check valve involving more than three valve films to form more than two gas passages is possible under the principle of the present invention.

The present invention discloses check valves of multiple-layer films involving three or more valve films to form two or more gas passage at the entrance of each gas pocket to speed up inflation process of an inflatable gas bag. Further, thinner valve film is used to improve the airtight effect and to reduce the problem of gas leakage after inflation.

While the invention has been described with referencing to preferred embodiments thereof, it is to be understood that modifications or variations may be easily made without departing from the spirit of this invention, which is defined by the appended claims.

What is claimed is:

1. The check valves of multiple-layer films are applicable in an inflatable gas bag, said inflatable gas bag comprises a upper film, a lower film, and check valves of multiple-layer films having a plurality of check valves being enclosed between upper film and lower film;
characterized in that check valves of multiple-layer films are made by binding a first valve film, a second valve film and a third valve film using hot press;
multiple anti-welding masks are printed between first valve film and second valve film, also between second valve film and third valve film;
there are two sets of passages, one between first valve film and second valve film, and another between second valve film and third valve film; and
multiple sets of gas passages act in parallel and therefore speed up the inflation process of the inflatable gas bag.

2. The check valves of multiple-layer films as defined in claim 1, wherein the thickness of first valve film is 20˜25 μm preferable.

3. The check valves of multiple-layer films as defined in claim 1, wherein the thickness of second valve film is 20˜25 μm preferable.

4. The check valves of multiple-layer films as defined in claim 1, wherein the thickness of third valve film is 20˜25 μm preferable.

5. The check valves of multiple-layer films as defined in claim 1, wherein the first, second and third valve films are hot pressed and bound onto the upper film through welding spots.

6. The check valves of multiple-layer films are applicable in an inflatable gas bag, said inflatable gas bag comprises a upper film, a lower film, and check valves of multiple-layer films having a plurality of check valves being enclosed between upper film and lower film;
characterized in that check valves of multiple-layer films are made by binding more than three valve films using hot press;
multiple anti-welding masks are printed between two neighboring valve films;
there are more than two sets of gas passages; and
multiple sets of gas passages act in parallel and therefore speed up the inflation process of the inflatable gas bag.

7. The check valves of multiple-layer films as defined in claim 6, wherein the thickness of each valve film is 20˜25 μm preferable.

8. The check valves of multiple-layer films as defined in claim 6, wherein the valve films are hot pressed and bound onto the upper film through welding spots.
